(19) United States
(12) Patent Application Publication
(10) Pub. No.: US 2024/0295425 A1
(43) Pub. Date: Sep. 5, 2024

(54) INJECTION NEEDLE BLOWOFF APPARATUS AND INJECTION TESTING SYSTEMS

(71) Applicant: Illinois Tool Works Inc., Glenview, IL (US)

(72) Inventor: Lindsay M. Euston, Boston, MA (US)

(21) Appl. No.: 18/588,683

(22) Filed: Feb. 27, 2024

Related U.S. Application Data
(60) Provisional application No. 63/488,053, filed on Mar. 2, 2023.

(51) Int. Cl. G01F 22/00

(52) U.S. Cl. CPC G01F 22/00

(57) ABSTRACT

An example injection needle blowoff apparatus includes: a positioning plate having a first side configured to contact an injector and having a second side opposite the first side; and a blowoff nozzle adjacent the second side of the positioning plate, the blowoff nozzle comprising: a gas inlet configured to be coupled to a gas supply; a gas channel coupled to the gas inlet; and a gas outlet configured to direct gas from the gas channel towards a location of a needle of the injector, wherein at least a portion of the gas outlet is defined by a portion of the second side of the positioning plate.

### RELATED APPLICATIONS

The present application claims the benefit of U.S. Provisional Patent Application Ser. No. 63/488,053, filed Mar. 2, 2023, entitled “INJECTION NEEDLE BLOWOFF APPARATUS AND INJECTION TESTING SYSTEMS.” The entirety of U.S. Provisional Patent Application Ser. No. 63/488,053 is expressly incorporated herein by reference.

### FIELD OF THE DISCLOSURE

This disclosure relates generally to injection device testing, and more particularly, to injection needle blowoff apparatus and injection testing systems.

### BACKGROUND

Injection testing systems may test one or more aspects of injection devices, including autoinjectors, for aspects such as cap removal force, plunger actuation force, injection depth, needle retraction, and/or delivered dose.

### SUMMARY

Injection needle blowoff apparatus and injection testing systems are disclosed, substantially as illustrated by and described in connection with at least one of the figures, as set forth more completely in the claims.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is an example injection testing system to perform testing of injection devices, in accordance with aspects of this disclosure.

FIG. 2 is a block diagram of an example injection testing system including an injection needle blowoff apparatus, in accordance with aspects of this disclosure.

FIG. 3 is a front elevation view of an example implementation of elements of the injection testing system of FIG. 2.

FIGS. 4A and 4B are perspective views of the example injection needle blowoff apparatus of FIG. 3 including a positioning plate and blowoff nozzles.

FIG. 5 is a bottom plan view of the example injection needle blowoff apparatus of FIG. 3.

FIG. 6 is a side elevation view of the example injection needle blowoff apparatus of FIG. 3.

FIG. 7 is a section view of the example injection needle blowoff apparatus of FIG. 6.

FIG. 8 is a perspective view of the example blowoff nozzle of FIG. 3.

FIG. 9 is a flowchart representative of example machine readable instructions which may be executed to implement the injection testing system of FIG. 2 to perform a measurement of an injector.

The figures are not necessarily to scale. Wherever appropriate, similar or identical reference numerals are used to refer to similar or identical components.

### DETAILED DESCRIPTION

Injection needle testing devices that measure the dosage delivered by the injection needle, particularly by autoinjectors, include a flask or other container positioned to capture and measure the fluid expelled from the needle. To accurately measure the expelled fluid, injection needle testing devices may include a blowoff or other method to detach the final quantity of expelled fluid, which can tend to remain adhered to the needle by fluid adhesion. Conventional needle testing devices may involve complex and/or costly manufacturing processes to achieve the desired blowoff gas flow, or may not provide preferred blowoff gas flow characteristics.

Additionally, conventional needle testing devices blow substantial amounts of gas to dislodge the final drop. In some cases, the blowoff gas may cause evaporation of the captured fluid contents, which can reduce the accuracy of the expelled fluid measurements.

Disclosed example injection needle blowoff apparatus and injection testing systems provide excellent blowoff gas flow characteristics, including supporting a range of needle lengths and gas velocity, with simpler and less expensive manufacturing techniques. Some example injection needle blowoff apparatus and injection testing systems are capable of blowing off needles of smaller length than conventional needle testing devices, such as by using a groove in a positioning plate to reduce the effective thickness of the positioning plate and/or to guide blowoff gas within the plate groove to impinge on the needle at a location closer to the positioning plate.

Some disclosed example injection needle blowoff apparatus and injection testing systems deliver gas to blowoff nozzles and, thus, to the needle, in one or more pulses of gas. The pulses of gas effectively dislodge the last drop of fluid from the injection needle while reducing or eliminating excess fluid evaporation from the last drop or the collected fluid. Disclosed example injection needle blowoff apparatus and injection testing systems may also have a higher likelihood of the last drop being collected by a collection container, instead of being blown away from the collection container as in conventional needle testing devices.

Disclosed example injection needle blowoff apparatus include: a positioning plate having a first side configured to contact an injector and having a second side opposite the first side; and a blowoff nozzle adjacent the second side of the positioning plate, the blowoff nozzle including: a gas inlet configured to be coupled to a gas supply; a gas channel coupled to the gas inlet; and a gas outlet configured to direct gas from the gas channel towards a location of a needle of the injector, wherein at least a portion of the gas outlet is defined by a portion of the second side of the positioning plate.

In some example injection needle blowoff apparatus, the blowoff nozzle is configured to have an adjustable distance from the injector along a plane of the second side of the positioning plate. In some example injection needle blowoff apparatus, the gas outlet includes at least one wall directed at an angle away from the second side of the positioning plate in a direction of gas flow. In some example injection needle blowoff apparatus, a cross-sectional area of the gas outlet increases as a distance from the gas channel increases.

In some example injection needle blowoff apparatus, the positioning plate includes a positioning plate having an aperture, extending from a first side of the positioning plate to a second side of the positioning plate. In some example injection needle blowoff apparatus, the blowoff nozzle is positioned on a first side of the aperture, and the apparatus further includes a second blowoff nozzle positioned on a second side of the aperture. In some example injection needle blowoff apparatus, the second blowoff nozzle includes: a second gas inlet configured to be coupled to the gas supply; a second gas channel coupled to the second gas inlet; and a second gas outlet configured to direct gas from the second gas channel towards the location of the needle of the injector, wherein at least a portion of the second gas outlet is defined by the second side of the positioning plate.

In some example injection needle blowoff apparatus, the aperture has at least one dimension smaller than a corresponding dimension of a body of the injector. In some example injection needle blowoff apparatus, the blowoff nozzle includes a body at least partially defining the gas channel and the gas outlet. In some example injection needle blowoff apparatus, the gas channel is at least partially enclosed by the positioning plate.

Some example injection needle blowoff apparatus further include the gas supply coupled to the gas inlet and a gas flow controller configured to control supply of the gas to the gas inlet to provide two or more pulses of the gas. In some example injection needle blowoff apparatus, the gas channel has a first cross-sectional area, the gas outlet has a second cross sectional area larger than the first cross sectional area, the gas outlet is configured to direct the gas at least partially away from the second side of the positioning plate.

In some example injection needle blowoff apparatus, the second side of the positioning plate includes a plate groove recessed from the second side, at least a portion of the gas outlet being defined by the plate groove. In some example injection needle blowoff apparatus, at least a portion of the gas channel is defined by the plate groove.

Disclosed example injection needle blowoff apparatus include: a positioning plate having a first side configured to contact an injector and having a second side opposite the first side; a blowoff nozzle adjacent the second side of the positioning plate, the blowoff nozzle configured to direct gas received via a gas inlet towards a location of a needle of the injector; and a gas flow controller configured to control the delivery of the gas to the gas outlet to supply pulses of gas.

In some example injection needle blowoff apparatus, the pulses of gas include bursts of gas in predetermined durations. Some example injection needle blowoff apparatus include a second blowoff nozzle, in which the gas supply is configured to supply the gas to the second blowoff nozzle in pulses of gas. In some example injection needle blowoff apparatus, the gas supply is configured to supply the pulses of gas to the blowoff nozzle and the second blowoff nozzle simultaneously. Some example injection needle blowoff apparatus include a collection container configured to collect the contents expelled from the injector.

In some example injection needle blowoff apparatus, the gas flow controller is configured to: determine, after the delivery of the gas to the blowoff nozzle, whether a drop is present on the needle; when the drop is still present on the needle after the delivery of the gas, adjust a parameter of the delivery of the gas to the blowoff nozzle to adjust the pulses of gas; and control a second delivery of the gas to the blowoff nozzle to supply second pulses of gas. In some example injection needle blowoff apparatus, the parameter of the delivery includes at least one of a gas pulse duration, a gas pressure, a pulse gas flow, or a time between gas pulses.

Disclosed example injection needle testing systems include: a positioning plate having a first side configured to contact an injector and having a second side opposite the first side; an injector positioner configured to position the injector in contact with the first side of the positioning plate; an injector actuator configured to actuate the injector to expel contents of the injector via a needle of the injector; and a blowoff nozzle adjacent the second side of the positioning plate, the blowoff nozzle including: a gas inlet configured to be coupled to a gas supply; a gas channel coupled to the gas inlet; and a gas outlet configured to direct gas from the gas channel towards a location of the needle of the injector, wherein at least a portion of the gas outlet is defined by a portion of the second side of the positioning plate.

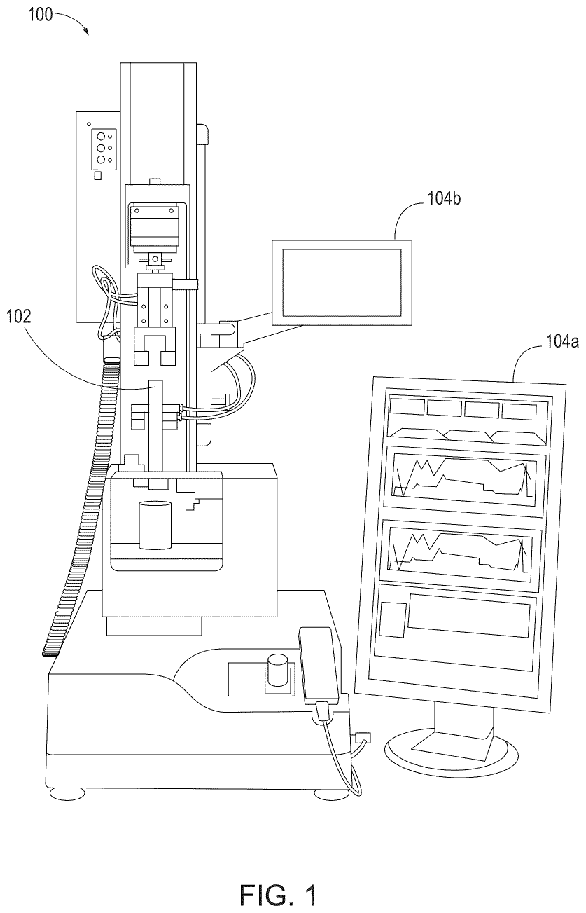

FIG. 1 is an example injection testing system 100 to perform testing on injection devices, such as an autoinjector 102. The example injection testing system 100 may be configured, for example, to perform some or all tests to evaluate requirements of the ISO 11608-5 standard. The example injection testing system 100 may be, for example, a universal testing system configured for injection testing.

The example injection testing system 100 of FIG. 1 includes positioning device(s) (e.g., to position the autoinjector 102 in one or more positions and/or orientations for automated testing), actuator(s) (e.g., to actuate components of the autoinjector 102, to actuate the positioning device(s), to position and/or orient test devices, etc.), and/or sensors to measure aspects of the autoinjector 102 during testing (e.g., load sensors to measure actuation force(s), auditory sensors to detect audible events), mass scales to measure an expelled dose, displacement and/or position sensors to trigger testing steps and/or measure displacement of components of the autoinjector 102, etc.). The example injection testing system 100 further includes one or more user interface devices, such as displays 104a, 104b and input devices 106.

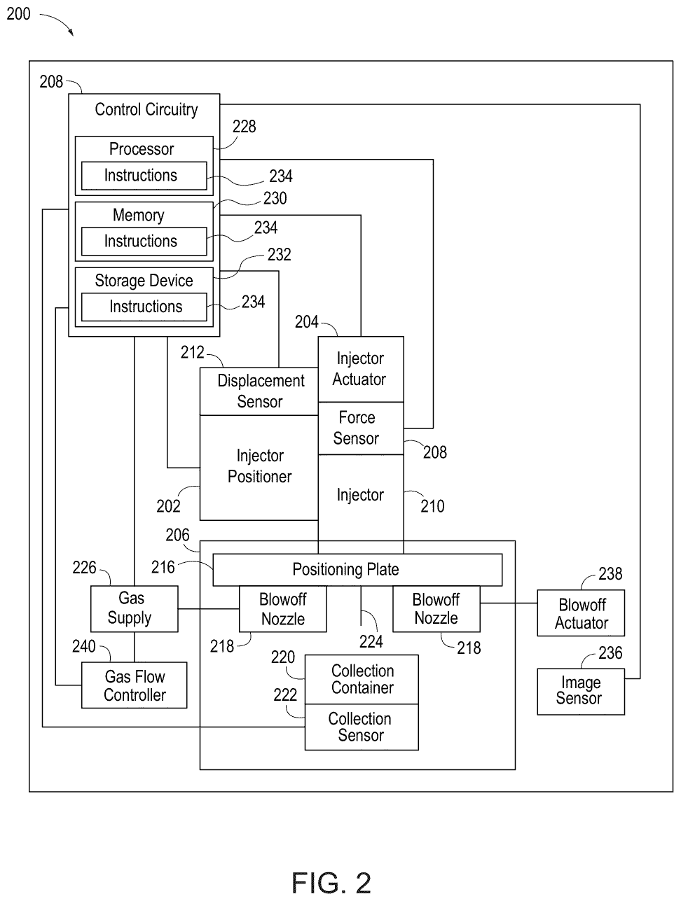

FIG. 2 is a block diagram of an example injection testing system 200 including an injection needle blowoff apparatus. The example injection testing system 200 may be used to implement some or all of the components of the injection testing system 100 of FIG. 1.

The example injection testing system 200 includes an injector positioner 202, an injector actuator 204, an injection collector 206, and control circuitry 208. The injector positioner 202 positions and/or orients an injector 210 (e.g., an autoinjector) for one or more tests in the injection testing system 200. For example, the injector positioner 202 may grasp the injector 210 and move and/or rotate the injector 210 for testing. The injector positioner 202 and/or the position of the injector 210 may be measured by one or more displacement sensor(s) 212, which provides displacement and/or position information to the control circuitry 208.

The injector actuator 204 actuates one or more aspects of the injector 210, such as a plunger or other injection mechanism of the injector 210. The force applied by the injector actuator 204 may by measured by a force sensor 214, which provides force measurements to the control circuitry 208.

The injection collector 206 includes a loading surface (e.g., a positioning plate 216), blowoff nozzles 218, and a collection container 220. The collection container 220 and the injector 210 are positioned such that, when the injector 210 is actuated to expel fluid contained in the injector 210, the fluid is expelled into the collection container 220. A collection sensor 222 measures the mass and/or volume collected in the collection container 220, and provides a mass or volume measurement to the control circuitry 208.

The positioning plate 216 allows a needle 224 of the injector 210 to extend through the positioning plate 216 toward the collection container 220. The positioning plate 216 may block the body 225 of the injector 210 from extending through the positioning plate 216 using appropriately sized apertures for the needle 224 and body 225 of the injector 210. To test the dispensing of the contained fluid, the injector positioner 202 may position the injector 210 to contact or abut the positioning plate 216, such that the needle 224 extends through the aperture of the positioning plate 216. When the injector 210 is positioned, the injector 210 may be actuated (e.g., manually, or automatically via the injector actuator 204) to expel the contents of the injector 210 into the collection container 220.

While the examples disclosed herein use the positioning plate 216 as a loading surface, other examples may use different types of loading surfaces against which the injector 210 can be actuated to expose the needle 224 and/or expel the contents of the injector 210. For example, rods or other structural members which are positioned to contact a body of the injector 210 on a top side of the loading surface, and to avoid obstructing the needle 224 may be used. In some such examples, the blowoff nozzles 218 may be coupled to another surface, or otherwise adjustably supported, within the injection collector 206 adjacent the bottom side of the loading surface and/or adjacent the location the needle 224.

At the completion of actuation of the injector 210, the blowoff nozzles 218 are controlled to blow the last drop of fluid from at or near the tip of the needle into the collection container 220. A gas supply 226 provides a gas, such as nitrogen or air, to the blowoff nozzles 218. The gas supply 226 may be, for example, a compressed gas source, a pneumatic pump, or a blower. The blowoff nozzles 218 may be positioned and/or oriented to adjust a location at which the blowoff gas strikes the needle 224, and/or may be positioned and/or oriented to cause the blowoff gas to strike the needle 224 over a range of needle lengths.

The example control circuitry 208 may be a general-purpose computer, a laptop computer, a tablet computer, and/or any other type of processing system configured to communicate with the sensors and actuators of the injection testing system 200. For example, the control circuitry 208 includes a processor 228, memory 230, and a storage device 232. The example processor 228 may be any general purpose central processing unit (CPU) from any manufacturer. In some other examples, the processor 228 may include one or more specialized processing units, such as RISC processors with an ARM core, graphic processing units, digital signal processors, and/or system-on-chips (SoC). The processor 228 executes machine readable instructions 234 that may be stored locally at the processor (e.g., in an included cache or SoC), in the memory (e.g., a random access memory or other volatile memory, a read only memory or other non-volatile memory such as FLASH memory, and/or in the storage device 232. The example storage device 232 may be a hard drive, a solid state storage drive, a hybrid drive, a RAID array, and/or any other mass data storage device.

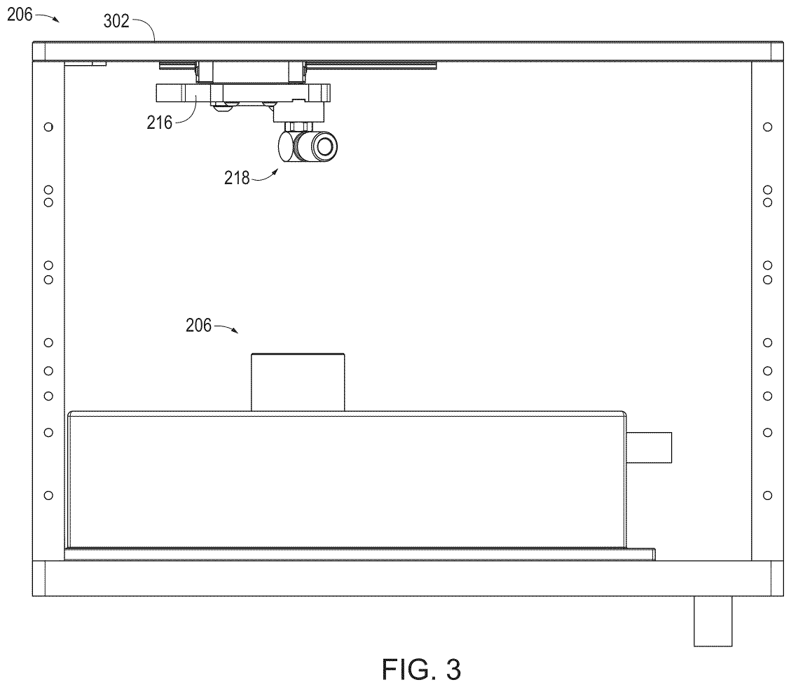

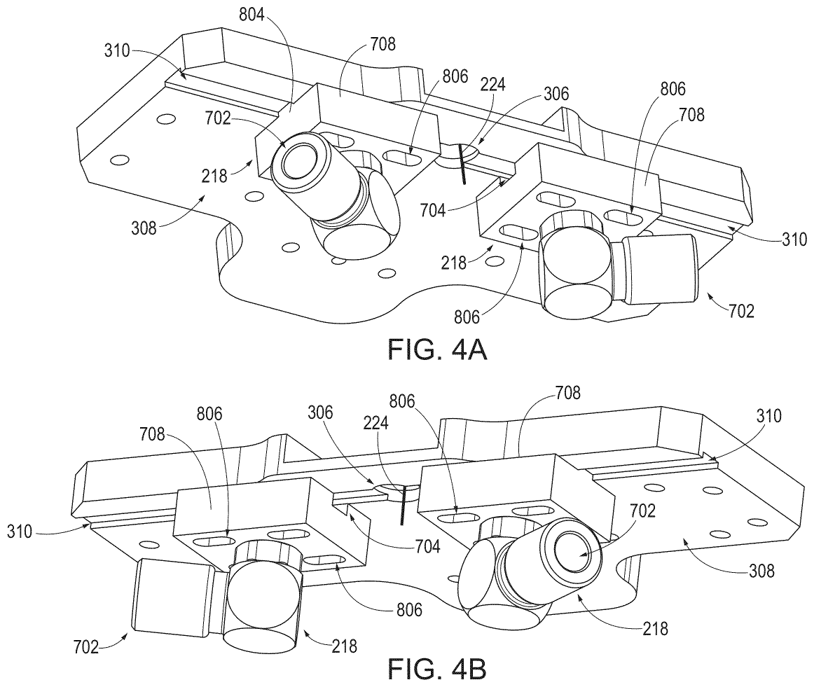

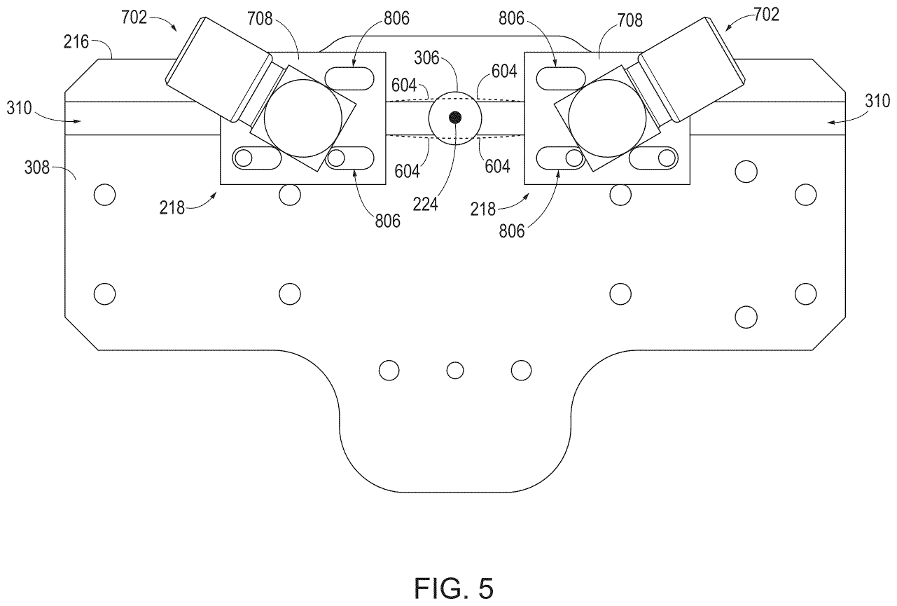

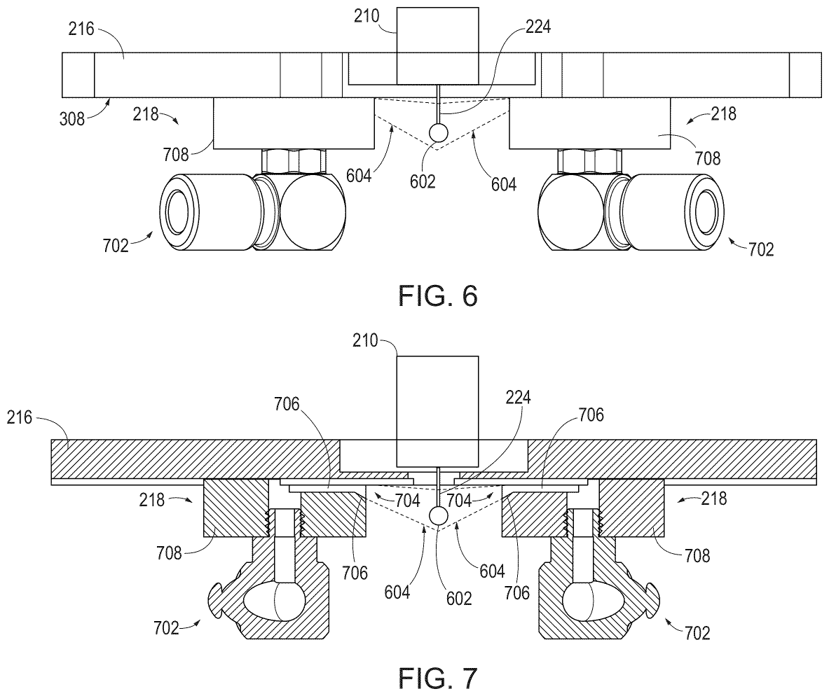

FIG. 3 is a front elevation view of an example implementation of the example injection collector 206 of FIG. 2. The injection collector 206 includes a housing 302, within which is located the positioning plate 216, blowoff nozzles 218, and a mass scale 304 (e.g., collection sensor 222 of FIG. 2). FIGS. 4A and 4B are perspective views of the example injection needle blowoff apparatus of FIG. 3 including the positioning plate 216 and blowoff nozzles 218. FIG. 5 is a bottom plan view of the example injection needle blowoff apparatus, and FIG. 6 is a side elevation view of the example injection needle blowoff apparatus of FIG. 3.

The positioning plate 216 is positioned below a top part of the housing 302, such that a top surface of the positioning plate 216 is accessible by the injector 210 through the housing 302. The positioning plate 216 is coupled to the housing 302, and may be replaced with other positioning plates to test different types of injectors (e.g., having different needle lengths, having different body dimensions). Replacement of the positioning plate 216 and attached blowoff nozzles 218 may allow more rapid changes to accommodate different testing procedures for different injectors.

The blowoff nozzles 218 are coupled to a bottom surface 308 of the positioning plate 216 on opposite sides of an aperture 306 in the positioning plate 216. The needle 224 of the injector 210 extends through the aperture 306 and sticks out the bottom side of the positioning plate 216. When the injector 210 is actuated, fluid is expelled from the needle 224 into the collection container 220 (e.g., positioned on the mass scale 304 below the needle 224).

As illustrated in FIG. 6, at the end of the expulsion of the fluid, the last quantity of the fluid tends to adhere to the needle 224 in the form of a drop 602. After the actuation is completed, the control circuitry 208 controls the gas supply 226 and/or the blowoff nozzles 218 (e.g., via a valve or other control device) to blow gas 604 toward the needle 224 to dislodge the drop 602 into the collection container 220.

FIG. 7 is a section view of the example injection needle blowoff apparatus of FIG. 6. As illustrated in FIG. 7, the example blowoff nozzles 218 each include a gas inlet 702, which are coupled to the gas supply 226 via a hose or other connection. As shown in FIG. 7, the blowoff nozzles 218 also include a gas outlet 704, which directs the gas received via the corresponding gas inlet 702 towards the location of the needle 224.

The gas inlets 702 are coupled to the respective gas outlets 704 via respective gas channels 706. Each gas channel 706 is partially implemented by passages through a body 708 of the corresponding blowoff nozzle 218. The gas inlet 702 may be implemented using a hose connector, which is connected to body 708 to provide fluid communication.

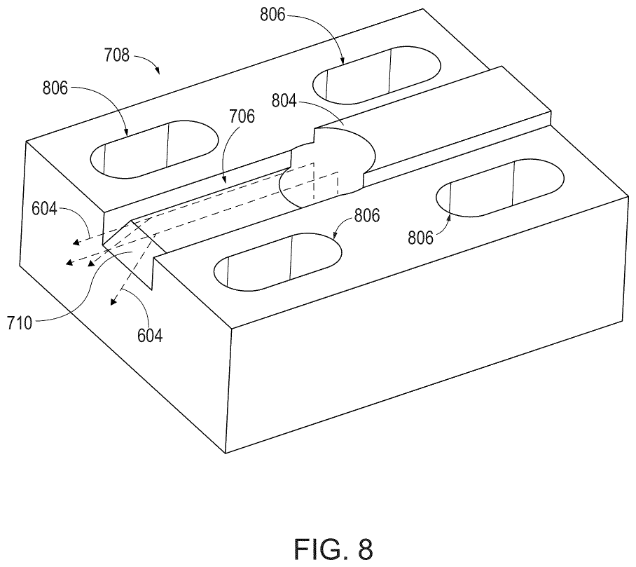

In the illustrated example, the gas channel 706 is at least partially enclosed by one or more surfaces of the positioning plate 216. FIG. 8 is a perspective view of the body 708 of the example blowoff nozzle of FIG. 3. As illustrated in FIG. 8, a top surface 802 of the body 708, which faces the bottom surface 308 of the positioning plate 216 when the body 708 is attached to the positioning plate 216. When the body 708 is attached to the positioning plate 216, the open side of the gas channel 706 is directly adjacent a portion of the bottom surface 308 of the positioning plate 216, which covers the open side of the gas channel 706 and provides an enclosure of the gas channel 706.

In some other examples, the portion of the gas channel 706 in the body 708 is enclosed by the surfaces of the body 708.

While the blowoff nozzles 218 are illustrated in FIGS. 4A-7 are illustrated as having separate gas inlets, gas channels, and gas outlets, in some examples two or more blowoff nozzles may be implemented using a shared gas inlet and/or at least a partially shared gas channel, such as a manifold having multiple gas outlets.

As illustrated in FIG. 8, the body 708 includes a protrusion 804. The protrusion 804 is configured (e.g., machined) to fit into a plate channel 310 (see FIG. 5) of the bottom surface 308 of the positioning plate 216 when the body 708 is attached to the bottom surface 308 of the positioning plate 216. The protrusion 804 and the plate channel 310 aligns the gas outlet 704 with the aperture 306 and/or the needle 224. The difference in widths between the protrusion 804 and the plate channel 310 may be selected such that the width of the gas outlet 704 directs the gas 604 toward the aperture 306 and/or the needle 224 despite any lateral shift between the protrusion 804 and the plate channel 310.

The plate channel 310 may have a depth that defines an effective thickness of the positioning plate 216 at the aperture and, as a result, determines a lower limit on needle length that can be effectively blown off. In the example of FIGS. 6 and 7, the plate channel 310 at least partially defines the gas outlet 704 and/or the gas channel 706, which allows the gas 604 to impinge on the needle 224 at a location closer to the bottom surface 308 of the positioning plate 216. As a result, lower needle lengths can be effectively blown off using the plate channel 310 as part of the gas outlet 704.

The body 708 includes slots 806 which align with fastener attachment points (e.g., threaded holes) to fasten the body 708 to the bottom surface 308 of the positioning plate 216. For example, screws, clips, cam locks, and/or other fasteners may be inserted through the slots 806 and into engagement with corresponding fastener attachment points. In other examples, the positioning plate 216 may include similar slots or through-holes to allow attachment of the body 708 to the housing 302 or to an intermediate structure between the positioning plate 216 and the housing 302. The example slots 806 are elongated to allow for adjustment of the position of the blowoff nozzles 218 without removal of the fasteners.

The example gas outlets 704 of FIG. 7 direct the gas 604 at least partially away from the bottom surface of the positioning plate 316. For example, the gas outlets 704 may each include at least one wall 710 directed at an angle away from the bottom surface 308 in a direction of the gas flow (e.g., in a direction leading away from the gas channel 706). The angled wall(s) 710 may be part of the body 708 and/or part of the positioning plate 216 (e.g., within the plate channel 310). For example, the plate channel 310 may include a wall or ramp that angles the gas 604 in a desired direction (e.g., outward from the plate channel 310 and toward the needle 224) from the gas outlet 704. The cross-sectional area of the gas outlet 704 also increases as the distance from the gas channel 706 increases (e.g., in a direction of gas flow). In other examples, the cross-sectional area of the gas outlet 704 may decrease as the distance from the gas channel 706 increases, such as by including a taper, ramp, or other angled surface from the plate channel 310 without a similar angled surface on the gas outlet 704.

The gas outlets 704 direct the gas 604 over a length of the needle 224, such that adjustments are not needed over a predetermined range of needle lengths. The blowoff nozzles 218 may have an adjustable distance from the aperture 306 and/or needle 224 (e.g., in the direction toward and away from the aperture 306 of the positioning plate 216) along a plane of the bottom surface 308 of the positioning plate 216 (e.g., parallel to the bottom surface 308 of the positioning plate 216, within a plane perpendicular to the needle 224, and/or in the direction of the plate channel 310). For example, the slots 806 may allow for a small amount of adjustment, and/or the slots 806 may be aligned with different attachment points to effect a larger adjustment.

The example gas supply 226 may be configured to provide a continuous stream of gas 604 for a predetermined duration to dislodge the last drop from the needle 224. In other examples, the control circuitry 208 controls the gas supply 226 to provide one or more shorter pulses of gas to the blowoff nozzles 218 to dislodge the last drop. The pulses may be formed as bursts of gas at a higher pressure and/or flow, and separated by durations of lower or no pressure or flow. The pulses of gas may be at least a threshold gas pressure, at least a threshold gas flow, and/or less than a threshold duration, and/or may be separated by at least a threshold duration.

The pulses of gas may be generated or controlled by controlling the delivery of gas to the gas inlet 702 and/or by controlling the delivery of gas to the gas outlet 704. For example, the gas supply 226 may be controlled to control output of gas, and/or a valve may be positioned between the gas supply 226 and the gas inlet 702, and/or between the gas inlet 702 and the gas outlet 704, and controlled to control the formation of the pulses of gas.

The example injection testing system 200 of FIG. 2 may further include a gas flow controller 240 that controls the delivery of gas from the gas supply 226 to the gas inlet 702 of the blowoff nozzles 218. For example, the gas flow controller 240 may control a valve, solenoid, and/or other gas flow control device of the gas supply 226 to allow, cut off, and/or regulate flow of gas. Additionally or alternatively, the gas flow controller 240 may control the gas supply 226 to adjust the gas pressure and/or gas flow delivered by the gas supply 226 to the gas inlet 702 (e.g., by controlling a gas regulator). The gas flow controller 240 and/or the gas supply 226 may include any appropriate type of electrical and/or mechanical devices to control the delivery and/or pressure and/or flow of the gas 604.

In some examples, the control circuitry 208 and/or the gas flow controller 240 may use sensor feedback (e.g., image analysis and/or object detection using the image sensor 236) to determine when the last drop has been dislodged. While the last drop is still detected on the needle 224, the control circuitry 208 and/or the gas flow controller 240 control the gas supply 226 to provide an additional pulse of gas 604. In some such examples, the control circuitry 208 and/or the gas flow controller 240 may adjust the parameters of the pulses, such as increasing or decreasing duration (e.g., pulse duration or constant gas duration), increasing or decreasing time between pulses, and/or increasing or decreasing gas pressure and/or flow.

The gas flow controller 240 may be implemented using any type of analog and/or digital control circuitry, such as a general purpose processor, an application specific processor, a programmable logic device, discrete circuitry, and/or any other circuit implementation. Additionally or alternatively, the gas flow controller 240 may use mechanical control to control the gas supply 226.

In some examples, the gas flow controller 240 adjusts the pressure, flow, and/or duration of the pulses of gas based on one or more properties of the fluid contained in the injector 210. For example, the gas flow controller 240 may receive information representative of the contents, viscosity, adhesion, and/or other properties, and determine a pressure, flow, and/or duration of the gas pulses. Lower viscosity fluids may use a lower pressure, flow, and/or duration (e.g., 10-20 PSI of pressure, less than 0.5 second duration), while higher viscosity fluids may use a higher pressure and/or duration (e.g., 15-25 PSI of pressure, up to 1.5 second duration).

The gas flow controller 240 may control the pulses of gas to be delivered to multiple blowoff nozzles 218 simultaneously or at different (e.g., alternating or cycling) times.

While the example gas outlet 704, the example gas channel 706, and the example plate channel 310 are illustrated as having flat and/or angled surfaces, in other examples any of the surfaces defining the gas outlet 704, the example gas channel 706, and/or the example plate channel 310 may be curved or rounded.

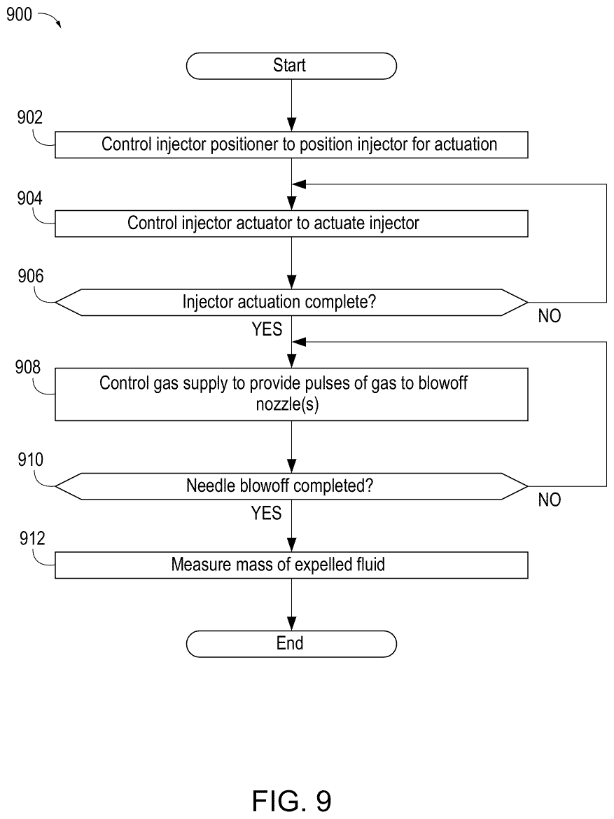

FIG. 9 is a flowchart representative of example machine readable instructions 900 which may be executed to implement the injection testing system 200 of FIG. 2 to perform a measurement of the injector 210. For example, the instructions 900 may be stored in the memory 230 or the storage device 232, and executed by the processor 228 to control the injection testing system 200. The instructions 900 may be used in conjunction with other tests or measurements performed on the injector 210 by the injection testing system 200.

At block 902, the control circuitry 208 (e.g., the processor 228) controls the injector positioner 202 to position the injector 210 for actuation. For example, the injector positioner 202 may move the body of the injector 210 near or into contact with the positioning plate 216 such that the needle is oriented to extend through the aperture 306.

At block 904, the control circuitry 208 controls the injector actuator 204 to actuate the injector 210. For example, the injector actuator 204 may actuate a plunger or other actuation device to cause the injector 210 to expel or dispense the contents of the injector 210.

At block 906, the control circuitry 208 determines whether the injector actuation is complete. For example, the injector actuator 204 may actuate the injector 210 a predetermined distance and/or up to a predetermined force (e.g., based on force sensor feedback). If the injector actuation is not complete (block 906), control returns to block 904 to continue actuation.

When the injector actuation is complete (block 906), at block 908 the control circuitry 208 and/or the gas flow controller 240 control the gas supply 226 to provide one or more pulses of gas to one or more blowoff nozzle(s) 218. The pulses of gas may have a defined duration, pressure, and/or flow, and are separated by periods without gas or with a reduced gas pressure or flow rate relative to the pulse of gas.

At block 910, the control circuitry 208 determines whether the needle blowoff is completed. For example, the control circuitry 208 may determine whether a target number of gas pulses has been delivered, and/or may use feedback to determine whether a last drop of fluid remains on the needle 224. If the needle blowoff is not completed (block 910), control returns to block 908 to deliver one or more additional pulses of gas.

When the needle blowoff is completed (block 910), at block 912 the control circuitry 208 measures a mass of expelled fluid via the collection sensor 222. The control circuitry 208 may store, display, report, and/or take other action with the measured quantity.

The example instructions 900 then end.

While disclosed examples include two blowoff nozzles on opposing sides of the needle, other examples may include a single blowoff nozzle, or three or more blowoff nozzles.

The present methods and systems may be realized in hardware, software, and/or a combination of hardware and software. The present methods and/or systems may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may include a general-purpose computing system with a program or other code that, when being loaded and executed, controls the computing system such that it carries out the methods described herein. Another typical implementation may comprise an application specific integrated circuit or chip. Some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein. As used herein, the term “non-transitory machine-readable medium” is defined to include all types of machine readable storage media and to exclude propagating signals.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

While the present method and/or system has been described with reference to certain implementations, it will be understood by those skilled in the art that various changes may be made and equivalents may be substituted without departing from the scope of the present method and/or system. For example, block and/or components of disclosed examples may be combined, divided, re-arranged, and/or otherwise modified. In addition, many modifications may be made to adapt a particular situation or material to the teachings of the present disclosure without departing from its scope. Therefore, the present method and/or system are not limited to the particular implementations disclosed. Instead, the present method and/or system will include all implementations falling within the scope of the appended claims, both literally and under the doctrine of equivalents.

What is claimed is:

1. An injection needle blowoff apparatus, comprising:
a positioning plate having a first side configured to contact an injector and having a second side opposite the first side; and
a blowoff nozzle adjacent the second side of the positioning plate, the blowoff nozzle comprising:
a gas inlet configured to be coupled to a gas supply;
a gas channel coupled to the gas inlet; and
a gas outlet configured to direct gas from the gas channel towards a location of a needle of the injector, wherein at least a portion of the gas outlet is defined by a portion of the second side of the positioning plate.

2. The injection needle blowoff apparatus as defined in claim 1, wherein the blowoff nozzle is configured to have an adjustable distance from the injector along a plane of the second side of the positioning plate.

3. The injection needle blowoff apparatus as defined in claim 1, wherein the gas outlet comprises at least one wall directed at an angle away from the second side of the positioning plate in a direction of gas flow.

4. The injection needle blowoff apparatus as defined in claim 3, wherein a cross-sectional area of the gas outlet increases as a distance from the gas channel increases.

5. The injection needle blowoff apparatus as defined in claim 1, wherein the positioning plate comprises a positioning plate having an aperture, extending from a first side of the positioning plate to a second side of the positioning plate.

6. The injection needle blowoff apparatus as defined in claim 5, wherein the blowoff nozzle is positioned on a first side of the aperture, and further comprising a second blowoff nozzle positioned on a second side of the aperture.

7. The injection needle blowoff apparatus as defined in claim 6, wherein the second blowoff nozzle comprises:
a second gas inlet configured to be coupled to the gas supply;
a second gas channel coupled to the second gas inlet; and
a second gas outlet configured to direct gas from the second gas channel towards the location of the needle of the injector, wherein at least a portion of the second gas outlet is defined by the second side of the positioning plate.

8. The injection needle blowoff apparatus as defined in claim 1, further comprising the gas supply coupled to the gas inlet and a gas flow controller configured to control supply of the gas to the gas inlet to provide two or more pulses of the gas.

9. The injection needle blowoff apparatus as defined in claim 1, wherein the blowoff nozzle comprises a body at least partially defining the gas channel and the gas outlet.

10. The injection needle blowoff apparatus as defined in claim 9, wherein the gas channel is at least partially enclosed by the positioning plate.

11. The injection needle blowoff apparatus as defined in claim 1, wherein the gas channel has a first cross-sectional area, the gas outlet has a second cross sectional area larger than the first cross sectional area, and the gas outlet is configured to direct the gas at least partially away from the second side of the positioning plate.

12. The injection needle blowoff apparatus as defined in claim 1, wherein the second side of the positioning plate comprises a plate groove recessed from the second side, at least a portion of the gas outlet being defined by the plate groove.

13. The injection needle blowoff apparatus as defined in claim 12, wherein at least a portion of the gas channel is defined by the plate groove.

14. An injection needle blowoff apparatus, comprising:
a positioning plate having a first side configured to contact an injector and having a second side opposite the first side;
a blowoff nozzle adjacent the second side of the positioning plate, the blowoff nozzle configured to direct gas received via a gas inlet towards a location of a needle of the injector; and
a gas flow controller configured to control the delivery of the gas to the blowoff nozzle to supply pulses of gas.

15. The injection needle blowoff apparatus as defined in claim 14, wherein the pulses of gas comprise bursts of gas in predetermined durations.

16. The injection needle blowoff apparatus as defined in claim 14, further comprising a second blowoff nozzle, the gas supply configured to supply the gas to the blowoff nozzle and the second blowoff nozzle simultaneously in pulses of gas.

17. The injection needle blowoff apparatus as defined in claim 14, wherein the gas flow controller is configured to:
determine, after the delivery of the gas to the blowoff nozzle, whether a drop is present on the needle;
when the drop is still present on the needle after the delivery of the gas, adjust a parameter of the delivery of the gas to the blowoff nozzle to adjust the pulses of gas; and
control a second delivery of the gas to the blowoff nozzle to supply second pulses of gas.

18. The injection needle blowoff apparatus as defined in claim 17, wherein the parameter of the delivery comprises at least one of a gas pulse duration, a gas pressure, a pulse gas flow, or a time between gas pulses.

19. The injection needle blowoff apparatus as defined in claim 14, wherein the gas supply is configured to supply the pulses of gas to the blowoff nozzle and the second blowoff nozzle simultaneously.

20. An injection needle testing system, comprising:
a positioning plate having a first side configured to contact an injector and having a second side opposite the first side;
an injector positioner configured to position the injector in contact with the first side of the positioning plate;
an injector actuator configured to actuate the injector to expel contents of the injector via a needle of the injector; and
a blowoff nozzle adjacent the second side of the positioning plate, the blowoff nozzle comprising:
a gas inlet configured to be coupled to a gas supply;
a gas channel coupled to the gas inlet; and
a gas outlet configured to direct gas from the gas channel towards a location of the needle of the injector, wherein at least a portion of the gas outlet is defined by a portion of the second side of the positioning plate.
